(19) United States
(12) Patent Application Publication
(10) Pub. No.: US 2019/0119053 A1
(43) Pub. Date: Apr. 25, 2019

(54) Feeding System

(71) Applicants: Tyco Electronics (Shanghai) Co. Ltd., Shanghai (CN); TE Connectivity Corporation, Berwyn, PA (US); Kunshan League Automechanism Co., Ltd., Kunshan City (CN)

(72) Inventors: Yingcong Deng, Shanghai (CN); Dandan Zhang, Shanghai (CN); Lvhai Hu, Shanghai (CN); Fengchun Xie, Shanghai (CN); Yun Liu, Shanghai (CN); Haidong Wu, Kunshan City (CN); Hui Xiao, Kunshan City (CN); Roberto Francisco-Yi Lu, Bellevue, WA (US)

(73) Assignees: Tyco Electronics (Shanghai) Co. Ltd., Shanghai (CN); TE Connectivity Corporation, Berwyn, PA (US); Kunshan League Automechanism Co., Ltd., Kunshan City (CN)

(21) Appl. No.: 16/169,298

(22) Filed: Oct. 24, 2018

(30) Foreign Application Priority Data
Oct. 25, 2017 (CN) 201711015439.1

(51) Int. Cl. B65G 65/44; B65G 61/00

(52) U.S. Cl. CPC B65G 65/44; B65G 61/00; B65G 2812/0344; B65G 2811/0626; B65G 2814/0344

(57) ABSTRACT

A feeding system comprises a hopper having a discharge port at a bottom of the hopper, a flow control gate disposed at the discharge port of the hopper, a sliding rail obliquely disposed below the hopper, and a vibration excitation unit. The hopper accommodates a plurality of different types of product components and each of the product components flows out from the discharge port of the hopper. A flow rate of the product components flowing out from the discharge port is adjustable by adjusting an opening degree of the flow control gate. The sliding rail is configured to receive the product components flowing out from the discharge port. The vibration excitation unit receives the product components from the sliding rail and is configured to separate the product components and to change a posture of the product components by virtue of vibration.

### CROSS-REFERENCE TO RELATED APPLICATION

This application claims the benefit of the filing date under 35 U.S.C. § 119(a)-(d) of Chinese Patent Application No. 201711015439.1, filed on Oct. 25, 2017.

### FIELD OF THE INVENTION

The present invention relates to a feeding system and, more particularly, to a feeding system for feeding product components.

BACKGROUND

In electronics manufacturing, it is necessary to mount various electronic components on a circuit board. An automatic feeding system is often employed in order to improve manufacturing efficiency. An automatic feeding system typically includes a hopper and a vibration tray. The hopper is used to accommodate electronic components to be fed. The electronic components fall from a bottom discharge port of the hopper to the vibration tray. The vibration tray reciprocally vibrates in one or more directions to change a posture of the electronic components on the vibration tray such that the electronic components are in a predetermined posture. When the electronic components are in the predetermined posture, the electronic components in the predetermined posture may be picked up by a manipulator.

The electronic components falling from the bottom discharge port of the hopper fall to the vibration tray at an uncontrollable speed, which causes the speeds of the electronic components falling from the bottom discharge port of the hopper to not match the vibration frequency of the vibration tray. As a result, the feeding efficiency is reduced.

### SUMMARY

A feeding system comprises a hopper having a discharge port at a bottom of the hopper, a flow control gate disposed at the discharge port of the hopper, a sliding rail obliquely disposed below the hopper, and a vibration excitation unit. The hopper accommodates a plurality of different types of product components and each of the product components flows out from the discharge port of the hopper. A flow rate of the product components flowing out from the discharge port is adjustable by adjusting an opening degree of the flow control gate. The sliding rail is configured to receive the product components flowing out from the discharge port. The vibration excitation unit receives the product components from the sliding rail and is configured to separate the product components and to change a posture of the product components by virtue of vibration.

### BRIEF DESCRIPTION OF THE DRAWINGS

The invention will now be described by way of example with reference to the accompanying Figures, of which:

FIG. 1 is a perspective view of a feeding system according to an embodiment.

### DETAILED DESCRIPTION OF THE EMBODIMENT(S)

Exemplary embodiments of the present disclosure will be described hereinafter in detail with reference to the attached drawings, wherein like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

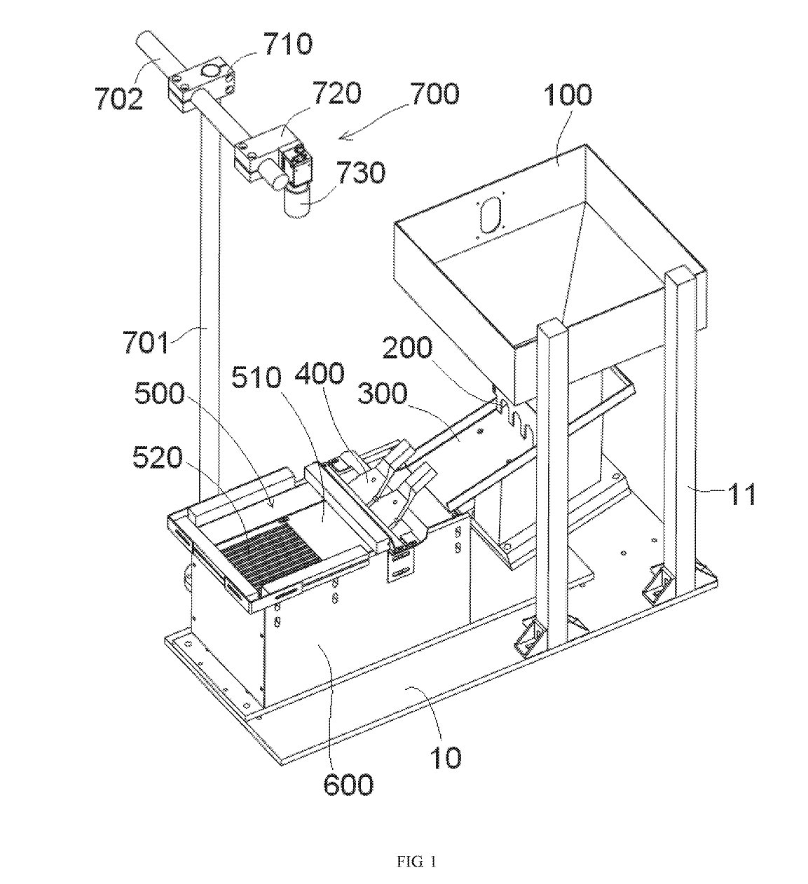

A feeding system according to an embodiment, as shown in FIG. 1, includes a hopper 100, a sliding rail 300, and a vibration excitation unit 500, 600.

The hopper 100, as shown in FIG. 1, is adapted to accommodate various different types of product components. In an exemplary embodiment, the different types of product components include, but are not limited to, electronic components, insulating components (such as plastic housings), metal components (such as conductive terminals), or semi-finished products. The hopper 100 includes a discharge port at bottom thereof, and the product components are adapted to flow out from the discharge port of the hopper 100 under gravity by a weight of each of the product components. The sliding rail 300 is obliquely disposed below the hopper 100 with respect to a horizontal plane, and has an upper end, at a right end in FIG. 1, at a high position and a lower end, at a left end in FIG. 1, at a low position so as to receive the product components flowing out from the discharge port of the hopper 100.

The vibration excitation unit 500, 600, as shown in FIG. 1, is disposed at the lower end of the sliding rail 300 and configured to receive the product components that slide off the lower end of the sliding rail 300. The vibration excitation unit 500, 600 includes a carrying table 500 for carrying the product components and a vibration generator 600 that drives the carrying table 500 to vibrate.

The carrying table 500, as shown in FIG. 1, is horizontally disposed relative to the horizontal plane. The carrying table 500 includes a smooth region 510 having a smooth surface and a rough region 520 having a rough surface. The smooth region 510 may also be referred to as a buffer region. The smooth region 510 of the carrying table 500 is located between the rough region 520 and the lower end of the sliding rail 300.

The feeding system, as shown in FIG. 1, further includes a gas blowing device 400 adapted to blow the product components fed to the smooth region 510 forward to the rough region 520. In an embodiment, the gas blowing device 400 includes a high pressure gas source and an gas blowing pipe connected to the high pressure gas source. The high pressure gas from the high pressure gas source is blown out through the gas blowing pipe to blow the product components to move forward on the carrying table 500.

The feeding system, as shown in FIG. 1, further includes a flow control gate 200 disposed at the discharge port of the hopper 100. A flow rate of the product components flowing out from the discharge port of the hopper 100 is adjustable by adjusting an opening degree of the flow control gate 200; the flow rate of the product components refers to the number of the product components that flow out from the discharge port of the hopper 100 per unit time.

Because the flow of the product components flowing out from the discharge port of the hopper 100 can be adjusted by adjusting the opening degree of the flow control gate 200, the opening degree of the flow control gate 200 can be adjusted so that the flow of the product components flowing out from the discharge port of the hopper 100 matches the vibration frequency of the vibration excitation unit 500, 600. In this way, the feeding efficiency of the feeding system is improved. In an embodiment, the flow control gate 200 may be a manual flow control gate or may be an automatic flow control gate. In the embodiment shown in FIG. 1, the flow control gate 200 is an automatic flow control gate controlled by a servo motor.

As shown in FIG. 1, the discharge port of the hopper 100 is positioned at the upper end of the sliding rail 300, and the product components flowing out from the discharge port of the hopper 100 directly fall to the upper end of the sliding rail 300, and slide along the sliding rail 300 to the lower end of the sliding rail 300. The lower end of the sliding rail 300 rests directly on the carrying table 500 such that the product components that slide out from the lower end of the sliding rail 300 directly move onto the carrying table 500.

The vibration generator 600, shown in FIG. 1, drives the carrying table 500 to reciprocally vibrate in at least one direction to separate the product components supplied to the carrying table 500 and change the posture or orientation of the product components. The vibration generator 600 drives the carrying table 500 to reciprocally vibrate in at least one of a horizontal direction and a vertical direction.

As shown in FIG. 1, the feeding system further includes a vision system 700 disposed above the carrying table 500 for identifying a position and a posture of the product components supplied to the carrying table 500. The feeding system further includes a manipulator adapted to pick up the product components in a predetermined posture, for example in a recumbent posture or an upright posture, from the carrying table 500 under visual guidance of the vision system 700. The vision system 700 may further be moved in a horizontal direction to adjust the position of vision system 700 in the horizontal direction.

The vision system 700, as shown in FIG. 1, includes a vertical slide bar 701, a first slider 710 slidably mounted on the vertical slide bar 701 so as to be movable along the vertical slide bar 701, a horizontal slide bar 702 mounted to the first slider 710, a second slider 720 slidably mounted on the horizontal slide bar 702 so as to be horizontally movable along the horizontal slide bar 702, and a camera 730 mounted on the second slider 720 so as to be vertically movable with the first slider 710 and so as to be horizontally movable with the second slider 720.

The feeding system, as shown in FIG. 1, further includes a fixed base 10 on which a plurality of support columns 11 are disposed. The hopper 100 is supported on the support columns 11. The sliding rails 300, the vibration excitation unit 500, 600 and the vision system 700 each are supported on the fixed base 10.

What is claimed is:

1. A feeding system, comprising:
a hopper having a discharge port at a bottom of the hopper, the hopper being configured to accommodate a plurality of different types of product components, each of the product components adapted to flow out from the discharge port of the hopper by a weight of the product component;
a flow control gate disposed at the discharge port of the hopper, a flow rate of the product components flowing out from the discharge port of the hopper is adjustable by adjusting an opening degree of the flow control gate;
a sliding rail having an upper end at a high position and a lower end at a low position, the sliding rail being obliquely disposed below the hopper with respect to a horizontal plane and being configured to receive the product components flowing out from the discharge port of the hopper; and
a vibration excitation unit disposed at the lower end of the sliding rail and receiving the product components that slide off the lower end of the sliding rail, the vibration excitation unit configured to separate the product components and to change a posture of the product components by virtue of vibration.

2. The feeding system of claim 1, wherein the plurality of different types of product components include a plurality of electronic components, a plurality of insulating components, a plurality of metal components, and/or a plurality of semi-finished products.

3. The feeding system of claim 1, wherein the vibration excitation unit includes a carrying table for carrying the product components and a vibration generator that drives the carrying table to vibrate.

4. The feeding system of claim 3, wherein the carrying table is horizontally disposed with respect to the horizontal plane, the carrying table includes a smooth region having a smooth surface and a rough region having a rough surface, the smooth region is located between the rough region and the lower end of the sliding rail.

5. The feeding system of claim 4, further comprising a gas blowing device adapted to blow the product components fed to the smooth region to the rough region.

6. The feeding system of claim 5, wherein the gas blowing device includes a high pressure gas source and a gas blowing pipe connected to the high pressure gas source, a high pressure gas from the high pressure gas source is blown out through the gas blowing pipe to blow the product components to move on the carrying table.

7. The feeding system of claim 1, wherein the opening degree of the flow control gate is adjustable such that the flow rate of the product components flowing out from the discharge port of the hopper matches a vibration frequency of the vibration excitation unit.

8. The feeding system of claim 1, wherein the flow control gate is a manual flow control gate or an automatic flow control gate.

9. The feeding system of claim 1, wherein the flow control gate is an automatic flow control gate controlled by a servo motor.

10. The feeding system of claim 1, wherein the discharge port of the hopper is positioned at the upper end of the sliding rail, and the product components flowing out from the discharge port of the hopper directly fall to the upper end of the sliding rail and slide along the sliding rail to the lower end of the sliding rail.

11. The feeding system of claim 3, wherein the lower end of the sliding rail rests directly on the carrying table such that the product components that slide out from the lower end of the sliding rail directly move onto the carrying table.

12. The feeding system of claim 3, wherein the vibration generator is configured to drive the carrying table to reciprocally vibrate in at least one direction so as to separate the product components fed to the carrying table and to change the posture of the product components.

13. The feeding system of claim 12, wherein the vibration generator is configured to drive the carrying table to reciprocally vibrate in at least one of a horizontal direction and a vertical direction.

14. The feeding system of claim 3, further comprising a vision system disposed above the carrying table and adapted to identify a location and the posture of the product components fed to the carrying table.

15. The feeding system of claim 14, further comprising a manipulator adapted to pick up the product components in a predetermined posture from the carrying table under visual guidance of the vision system.

16. The feeding system of claim 14, wherein the vision system is movable up and down in a vertical direction to adjust a distance between the vision system and the carrying table in the vertical direction.

17. The feeding system of claim 16, wherein the vision system includes a vertical slide bar, a first slider slidably mounted on the vertical slide bar so as to be movable up and down along the vertical slide bar, and a camera mounted on the first slider so as to be movable up and down with the first slider.

18. The feeding system of claim 16, wherein the vision system is movable in a horizontal direction to adjust a position of the vision system in the horizontal direction.

19. The feeding system of claim 18, wherein the vision system includes a vertical slide bar, a first slider slidably mounted on the vertical slide bar so as to be movable up and down along the vertical slide bar, a horizontal slide bar mounted to the first slider, a second slider slidably mounted on the horizontal slide bar so as to be horizontally movable along the horizontal slide bar, and a camera mounted on the second slider so as to be movable up and down with the first slider and to be horizontally movable with the second slider.

20. The feeding system of claim 1, further comprising a fixed base on which a plurality of support columns are disposed, the hopper is supported on the support columns.
